(19) United States
(12) Patent Application Publication
(10) Pub. No.: US 2015/0178641 A1
(43) Pub. Date: Jun. 25, 2015

(54) CHECK-IN METHOD

(71) Applicant: NCR Corporation, Duluth, GA (US)

(72) Inventor: Rafael Yepez, Duluth, GA (US)

(73) Assignee: NCR Corporation, Duluth, GA (US)

(21) Appl. No.: 14/134,327

(22) Filed: Dec. 19, 2013

(51) Int. Cl. G06Q 10/02; H04W 12/06

(52) U.S. Cl. CPC G06Q 10/02; H04W 12/06

(57) ABSTRACT

A check-in method which streamlines the customer experience by automating many check-in steps. An example method involving passenger check-in for a flight includes wirelessly transmitting signals by a mobile communication device, receiving within a check-in area a response message from an airline system by the mobile communication device, sending check-in information to the airline system by the mobile communication device in response to the message, and receiving a mobile boarding pass from the airline system by the mobile communication device.

### BACKGROUND

The present invention relates to check-in systems and methods.

In one example, airline check-in methods involve several manual steps, one of which is either downloading a mobile/digital boarding pass to a smart phone or printing a paper boarding pass at a kiosk or home computer.

It would be desirable to provide a check-in method which streamlines the customer experience in travel and other venues by automating many check-in steps.

### SUMMARY

In accordance with the teachings of the present invention, a check-in method is provided.

An example method includes wirelessly transmitting signals by a mobile communication device, receiving a message from a host system through a wireless communication infrastructure within a check-in area by the mobile communication device in response to the signals, sending check-in information to the host system through the wireless communication infrastructure by the mobile communication device in response to the message, and receiving a token from the host system through the wireless communication infrastructure by the mobile communication device.

An example method involving passenger check-in for a flight includes wirelessly transmitting signals by a mobile communication device, receiving a response message from an airline system through a wireless communication infrastructure within a check-in area by the mobile communication device, sending check-in information to the airline system through the wireless communication infrastructure by the mobile communication device in response to the message, and receiving a mobile boarding pass from the airline system by the mobile communication device through the wireless communication infrastructure.

Check-in information may include information for authenticating passenger mobile communication devices.

An example wireless communication infrastrtucuture includes a plurality of Bluetooth Low Energy (BLE) standard beacons arranged within the check-in area.

Another example wireless communication infrastrtucuture includes a plurality of wireless network access points (Wi-Fi).

### BRIEF DESCRIPTION OF THE DRAWINGS

FIG. 1 is a block diagram of an example travel system.

FIG. 2 is a flow diagram illustrating an example method of facilitating check-in.

FIG. 3 is a flow diagram illustrating an example check-in method.

### DETAILED DESCRIPTION

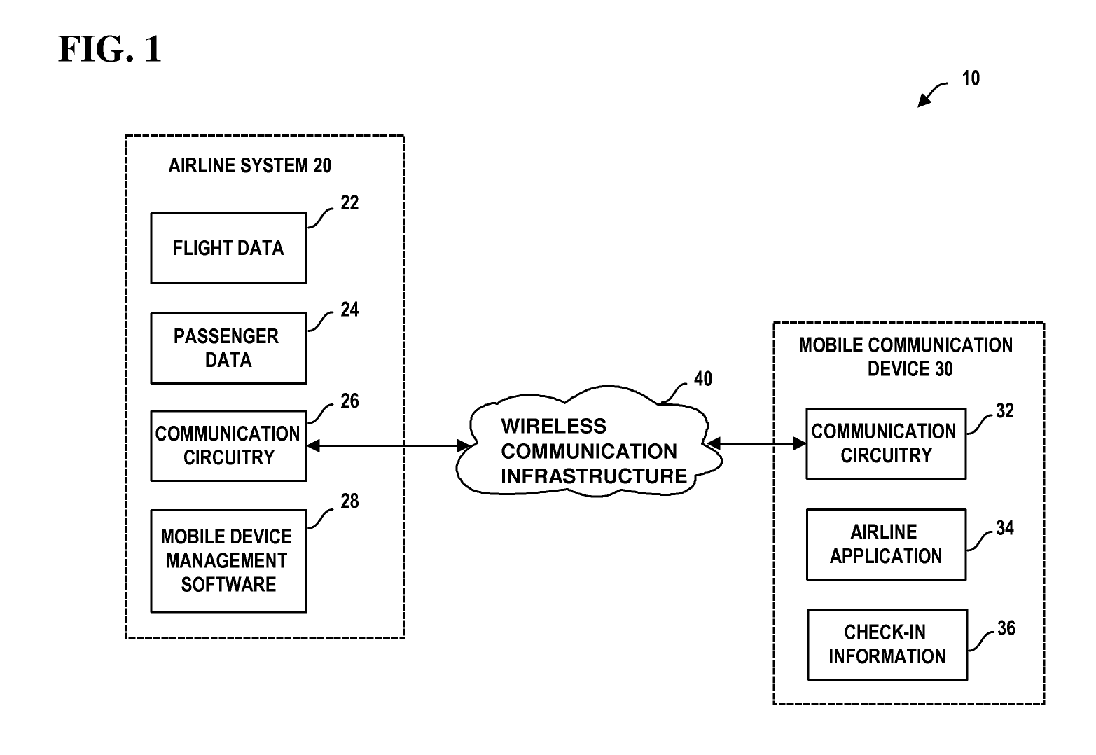

Turning now to FIG. 1, travel system 10 is illustrated in an air travel example in which a mobile communication device 30 receives a mobile boarding pass. Other venues requiring check-in, which may include admission or other access, to receive an admission token are also envisioned, as well as other travel systems, such as rail and bus service.

Example travel system 10 primarily includes one or more airline systems 20. Airline system 20 includes one or more servers including one or more processors, memory, and program and data storage. Airline system 20 may be configured to execute an operating system such as a Microsoft or Linux operating system. Airline system 20 further includes circuitry for connecting to a network, which may include any combination of wireless or wired networks, including local area, wide area, virtual private, and global communication networks, such as the Internet. Airline system 20 may further include other circuitry for connecting other peripherals, such as a display, a printer, a mouse, and a keyboard.

Airline system 20 may include World Wide Web (“web”) compatible server software which hosts a web site including web pages, web applications and other web content. Passengers may visit the web site to make or change reservations and to check-in for flights from computers, such as mobile communication device 30, equipped with web browser software. The web site may include or provide airline application 34, including a version written to be executed within the operating system of mobile communication device 30. A passenger may download airline application 34, in advance of check-in, through a conventional wired or wireless network connection.

Airline system 20 maintains one or more databases containing flight data 22 and passenger data 24. Flight data 22 may include information about each scheduled flight. Passenger data 24 may include passenger identification information and other information, such as information identifying a passenger and a passenger's mobile communication device 30. Flight data 22 and/or passenger data 24 also includes an indication whether a passenger has checked in for a flight.

For example, passenger data 24 may include any of an Internet Protocol address, serial number, or other data that is also stored within mobile communication device 30 within check-in information for the purpose of recognizing and authenticating passenger mobile communication devices 30. A passenger may pre-register themselves and their mobile communication devices 30 with an airline through an airline website to provide this information, for example, when making a reservation.

Airline system 20 may also include third part host computers that store and manage some of the flight data 22 and passenger data 24 in a Departure Control System (DCS) for an airline.

Airline system 20 further includes communication circuitry 26 which communicates with wireless communication infrastructure 40. Communication circuitry 26 is supported by additional communication software and/or drivers or may be fully supported by the operating system itself.

Airline system 20 executes mobile device management software 28 which receives information from and sends information to mobile communication device 30 through wireless communication infrastructure 40 and communication circuitry 26.

For example, mobile device management software 28 may deliver or “push” offers and promotions, such as flight upgrades, to passengers through their mobile communication devices 30. Mobile device management software 28 may automatically execute airline application 34 to notify the passenger of the offers and promotions.

Mobile device management software 28 may further deliver offers and promotions from airport merchants using airline application 34 or one or more different applications executed by mobile communication device 30, such as a merchant application or airport application.

As another example, mobile device management software 28 may determine whether the passenger is in the airport environment by communicating with mobile communication device 30 through wireless communication infrastructure 40. Mobile device management software 28 may also track or obtain the passenger's location in the airport environment. Mobile device management software 28 may send alert messages to mobile communication device 30 when the passenger is not at the gate and the passenger's flight is about to leave the gate.

As yet another example, mobile device management software 28 may initiate a passenger check-in process on mobile communication device 30.

Mobile management software 28 may trigger airline application 34 to automatically obtain check-in information 36 from a storage area within mobile communication device 30, send check-in information, and receive a mobile boarding pass, all without passenger involvement. Alternatively, mobile management software 28 may trigger airline application 34 as an alert to the passenger to manually complete the check-in process and/or receive a mobile/digital boarding pass from airline system 20.

In one example embodiment, mobile device management software 28 compares check-in information 36 previously stored by the passenger within mobile communication device 30 to passenger data 24 and/or flight data 22 to recognize and authenticate mobile communication device 30, and to determine whether the passenger has already checked-in. If the passenger has not already checked-in, airline system 20 sends a mobile boarding pass to mobile communication device 30 if the comparison is true, sends a message alerting the passenger, and changes passenger data 24 to reflect that the passenger has checked in.

As an additional security precaution, mobile management software 28 may, prior to sending the mobile boarding pass, send an alert message to the passenger requesting that the passenger enter information authenticating the passenger, such as a personal identification number (PIN).

In one example embodiment, wireless communication infrastructure 40 may include a Bluetooth Low Energy (BLE) standard wireless beacon. Many such beacons may be distributed in an airport environment to form the wireless communication infrastructure. For example, beacons may be placed within a check-in area and/or elsewhere within an airport. The beacons communicate with communication circuitry 26 in airline system 20 and with communication circuitry 32 in compatible mobile communication devices 30 that are configured with Bluetooth services in the “on” position and that are within range of any beacon (up to about 45 meters).

As another example, wireless communication infrastructure 40 may include a wireless network access point of a standard IEEE 802.11 wireless network (Wi-Fi). Many such wireless network access points beacons may be distributed in an airport environment to form the wireless communication infrastructure.

Mobile communication device 30 may include a smart phone, personal digital assistant, tablet computing device, or other portable communication device that includes communication circuitry 32 and software capable of communicating with BLE standard wireless protocol beacons. Communication circuitry 32 and corresponding BLE compatible software detects broadcasts from wireless communication infrastructure 40 and passes information in the broadcasts to airline application 34.

Mobile communication device 30 may include one or more processors, memory, and program and data storage. Mobile communication device 30 may execute an operating system such as a Microsoft, Google, or Apple operating system. Mobile communication device 30 may execute other computer software, such as web browser software, which may be stored in a computer readable medium. Computer system 14 further includes wired and/or wireless network circuitry, circuitry for connecting to the network, and other peripherals, such as a touch screen or a display and keypad.

To facilitate check-in, airline application 34 may automatically obtain information uniquely identifying mobile communication device 30, the passenger, the flight, and/or passenger preferences, such as luggage amount, seating (e.g., aisle, window, or whatever is available), upgrades, and early boarding from a storage area within mobile communication device 30. The information may be stored as check-in information 36.

Check-in information 36 may further include PIN and/or other information for authenticating the passenger.

Check-in information 36 may further include payment information, such as credit card information, for use in purchasing upgrades and paying luggage and other fees. Alternatively, payment information may include instructions to pay with a preferred credit card stored in passenger data 24.

Airline application 34 may facilitate storage of check-in information 36, for example, when the passenger makes a reservation.

Upon arrival at the airport, airline application 34 may automatically send check-in information 36 to airline system 20 in response to a message from mobile device management software 28. Airline application 34 receives a mobile boarding pass and a message alerting the passenger from mobile device management software 28. The passenger may then complete a security process, which may include a visual check of the mobile boarding pass and a picture identification document, at a security checkpoint.

Airline application 34 may also provide directions to airport locations, such as the departure gate and merchant locations, using signals received from wireless communication infrastructure 40.

Mobile communication device 30 may download airline application 34 from a website hosted by airline system 20. In one example embodiment, airline application 34 may be written in a programming language such as the Java programming and be hosted within the browser software executed by mobile communication device 30.

As another example, airline application 34 may include a script, such as JavaScript, combined with hypertext markup language (HTML) or other suitable web page language.

As another example, airline application 34 may include a software applet written to be executed within the operating system of mobile communication device 30.

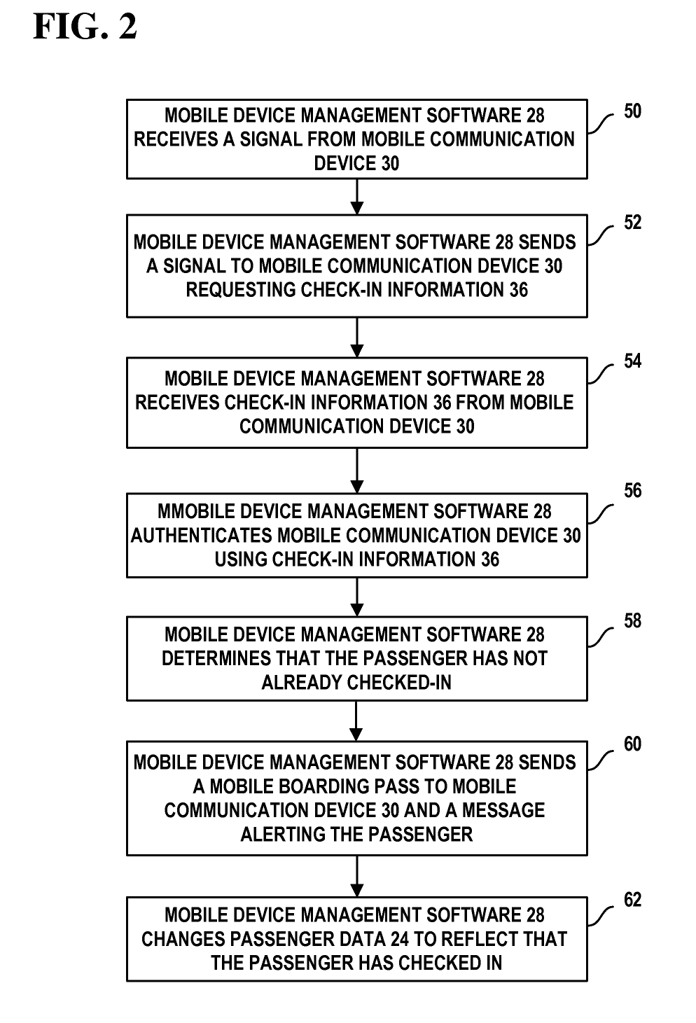

With reference to FIG. 2, an example method of facilitating check-in is illustrated beginning with step 50.

In step 50, mobile device management software 28 receives a signal from mobile communication device 30 through wireless communication infrastructure 40 and communication circuitry 26.

In step 52, mobile device management software 28 sends a signal to mobile communication device 30 requesting check-in information 36.

In step 54, mobile device management software 28 receives check-in information 36 from mobile communication device 30.

In step 56, mobile device management software 28 authenticates mobile communication device 30 using check-in information 36. Mobile device management software 28 compares check-in information 36 to flight data 22 and/or passenger data 24.

In step 58, mobile device management software 28 determines from flight data 22 and/or passenger data 24 that the passenger has not already checked-in.

In step 60, mobile device management software 28 sends a mobile boarding pass to mobile communication device 30 and a message alerting the passenger.

In step 62, mobile device management software 28 changes passenger data 24 to reflect that the passenger has checked in.

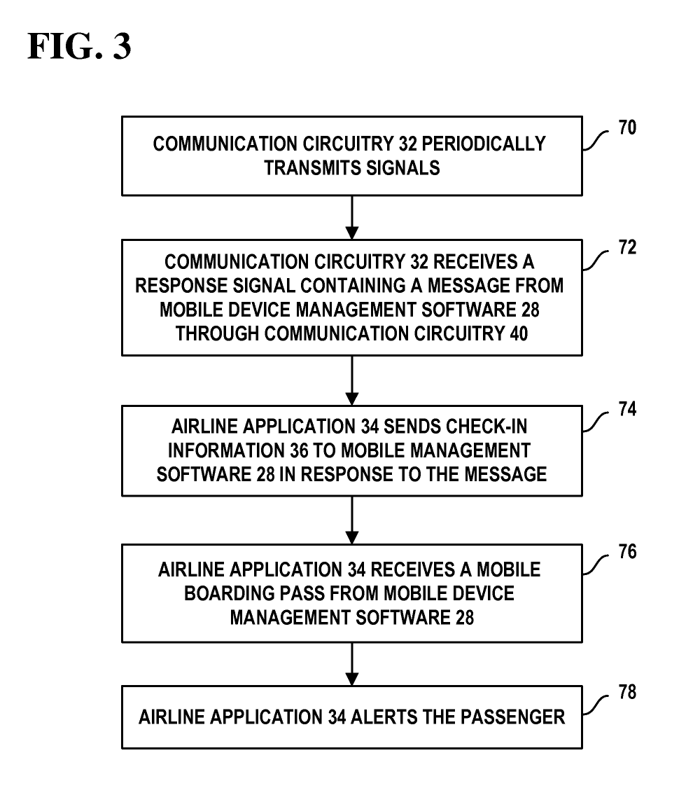

With reference to FIG. 3, an example check-in method is illustrated beginning with step 70. The example method streamlines the passenger experience by automating many check-in steps.

In step 70, communication circuitry 32 periodically transmits signals. The signals advertise the ability of communication circuitry 32 to receive response signals.

In step 72, communication circuitry 32 receives a response signal from mobile device management software 28 through wireless communication infrastructure 40. The response signal contains a message from mobile device management software 28.

In step 74, airline application 34 sends check-in information 36 to mobile management software 28 in response to the message from mobile device management software 28. Check-in information includes information for authenticating passenger mobile communication devices 60.

In step 76, airline application 34 receives a mobile boarding pass and an alert message from mobile device management software 28, indicating that mobile device management software 28 had authenticated the passenger's mobile communication device 60 and determined that the passenger had not already checked in.

If the comparison were false, then airline application 34 would prompt the passenger to manually complete each check-in process step.

In step 78, airline application 34 receives a mobile boarding pass from mobile device management software 28.

The passenger may then complete a security process at an airport security checkpoint, which may include a visual check of the mobile boarding pass and a picture identification document, at a security checkpoint. As an additional security precaution, mobile management software 28 may, prior to sending the mobile boarding pass, send an alert message to the passenger requesting that the passenger enter information authenticating the passenger, such as a personal identification number (PIN).

Airline application 34 may also provide directions to airport locations, such as the departure gate and merchant locations, using signals received from wireless communication infrastructure 40.

Although the present invention has been described with particular reference to certain preferred embodiments thereof, variations and modifications of the present invention can be effected within the spirit and scope of the following claims.

What is claimed is:

1. A check-in method comprising:
sending signals by a mobile communication device;
receiving a message within a check-in area from a host system through a wireless communication infrastructure by the mobile communication device in response to the signals;
sending check-in information to the host system through the wireless communication infrastructure by the mobile communication device in response to the message; and
receiving a token from the host system through the wireless communication infrastructure by the mobile communication device.

2. The method of claim 1, wherein the wireless communication infrastructure comprises a plurality of Bluetooth Low Energy (BLE) standard beacons.

3. The method of claim 1, wherein the wireless communication infrastructure comprises a plurality of wireless network access points.

4. The method of claim 1, wherein the check-in information comprises information for authenticating the mobile communication device.

5. The method of claim 4, wherein the check-in information comprises an Internet Protocol address of the mobile communication device.

6. The method of claim 4, wherein the check-in information comprises a serial number of the mobile communication device.

7. The method of claim 1, wherein the check-in information comprises luggage amount.

8. The method of claim 1, wherein the check-in information comprises a seating preference.

9. The method of claim 1, wherein the check-in information comprises an early boarding preference.

10. The method of claim 1, wherein the check-in information comprises payment information.

11. The method of claim 1, wherein the check-in information comprises passenger authenticating information.

12. The method of claim 1, wherein the check-in information comprises passenger authenticating information.

13. The method of claim 12, further comprising receiving another message by the mobile communication device from the host system requesting information authenticating the user of the mobile communication device prior to receiving a token.

14. The method of claim 1, wherein the token comprises a mobile boarding pass.

15. The method of claim 1, further comprising receiving promotions by the mobile communication device.

16. The method of claim 1, further comprising receiving directions by the mobile communication device.

17. The method of claim 1, further comprising receiving by the mobile communication device a departure alert message based upon a location of the mobile communication device.

18. A check-in method comprising:
saving by a mobile communication device check-in information in a storage area of the mobile communication device, wherein the check-in information includes information identifying the mobile communication device;
sending signals by a mobile communication device;
receiving within a check-in area a message from a host system in response to the signals through a wireless communication infrastructure by the mobile communication device;
obtaining the check-in information from the storage area by the mobile communication device;
sending the check-in information to the host system through the wireless communication infrastructure by the mobile communication device; and
receiving a token from the host system through the wireless communication infrastructure by the mobile communication device.

19. The method of claim 18, wherein the check-in information is saved during registration with the host system.

20. A mobile communication device comprising:
wireless communication circuitry;
a storage area for storing check-in information;
a memory containing software; and
a processor configured with the software to cause the mobile communication device to
send signals;
receive within a check-in area a message from a host system through a wireless communication infrastructure in response to the signals;
send check-in information to the host system through the wireless communication infrastructure in response to the message; and
receive a token from the host system through the wireless communication infrastructure.
